(19) United States
(12) Patent Application Publication
(10) Pub. No.: US 2021/0327603 A1
(43) Pub. Date: Oct. 21, 2021

(54) PROCESS FOR THE PRODUCTION OF GALLIUM RADIONUCLIDES

(71) Applicant: UNIVERSITETET I OSLO, Oslo (NO)

(72) Inventors: Bent Wilhelm SCHOULTZ, Ås (NO); Gjermund HENRIKSEN, Mjøndalen (NO)

(21) Appl. No.: 17/273,134

(22) PCT Filed: Sep. 3, 2019
(86) PCT No.: PCT/EP2019/073463

§ 371 Date: Mar. 3, 2021

(30) Foreign Application Priority Data
Sep. 3, 2018 (GB) 1814291.9

(51) Int. Cl. G21G 1/10; G21K 5/08

(52) U.S. Cl. CPC G21G 1/10; G21G 2001/0021; G21K 5/08

(57) ABSTRACT

The invention provides a process for the production of gallium radionuclides, comprising irradiating a ceramic zinc phosphate target with a proton beam.

This invention concerns a process for the production of gallium radionuclides. In particular, the invention relates to a process for producing gallium radionuclides comprising irradiating a ceramic zinc phosphate target with a proton beam. The process is particularly suitable to applications wherein the proton beam is provided by a cyclotron. The invention also relates to the use of ceramic zinc phosphate as a target in the production of gallium radionuclides.

### BACKGROUND

The global use of nuclear medicine, valued to 9.6 billion USD in 2016, accounts for more than 40 million procedures annually. With a prospected annual increase of 5%, the global radioisotope market is expected to reach 17 billion USD by 2021. Medical radioisotopes account for 80% of the global market of radioisotopes. They can be employed as therapeutic or imaging agents for radiation therapy or for the labeling of biologically important molecules, such as small molecular weight organic compounds, peptides, proteins and antibodies.

Positron Emission Tomography (PET) technology has the ability to provide functional and quantitative imaging. PET is a non-invasive medical imaging technology which is useful for generating high-resolution images which can be used in diagnostic applications in the fields of oncology, neurology and cardiology, for example. Single-photon emission computed tomography (SPECT) is another important imaging technique, used mainly in the field of nuclear cardiology using ^{99m}Tc. The relative ease of production of this radionuclide (from ⁹⁹Mo), together with its relatively low cost, have resulted in the employment of this technology in around 80% of all nuclear medicine procedures in the field of nuclear cardiology, however there are limitations with in vivo quantification. In other applications, such as oncology, the need to perform quantitative imaging means that PET tracers are preferred.

Supplies of ⁹⁹Mo for ^{99m}Tc generators are predicted to drop significantly in the coming years, in part due to decommissioning of nuclear reactor production plants. Together with ^{99m}Tc's limited versatility, this has prompted considerable technological development of PET methods, including more efficient cyclotrons to improve availability of PET isotopes. As a result, more cost effective PET radiopharmaceuticals are emerging, leading to an increase in PET facilities worldwide, in particular those with cyclotrons for in house production of short-lived PET radionuclides.

The most commonly used. PET radionuclide is ¹⁸F (t½=109.7 m) for the production of [¹⁸F]fluorodeoxy glucose (FDG), the radiopharmaceutical used in approximately 80% of all PET investigations. The development of a ⁶⁸Ga (t½=67.6 m) generator in 2005 led to the opportunity to produce PET tracers with chemistry almost as simple as ^{99m}Tc chelating chemistry. Chelating chemistry is often quantitative and simple compared to the far more cumbersome ¹⁸F-labeling chemistry in PET tracer production. One restriction which prevents the utilization of ⁶⁸Ga on a similar scale to ¹⁸F is the current generator technologies, which have a low output and capacity, as well as a high cost (70-80 kEUR). Commercial ⁶⁸Ga generators apt to good manufacturing practice (GMP) are limited to 50 mCi (1.9 GBq) at time of delivery. At the most, when they are new, they can produce three patient doses in a day but will after only four months lose half of the capacity, two months before their decommissioning. The low performance and high price of ⁶⁸Ga generators is thus hampering the opportunity for the realization of the full potential of ⁶⁸Ga to produce and deliver patient doses of ⁶⁸Ga PET tracers to external nuclear medicine centers.

Recently, PET facilities with in-house cyclotrons have started to explore the production of ⁶⁸Ga directly from ⁶⁸Zn. At least two large vendors of cyclotrons, IBA and GE Healthcare, offer cyclotron targets based on a liquid ⁶⁸Zn-solution. These liquid targets are described in, for example, WO 2015/175972. The liquid target provides <4 GBq ⁶⁸Ga, with a production rate of about 192.5 MBq/μAh, which is comparable to the initial activity levels obtained from two new ⁶⁸Ge/⁶⁸Ga generators. Moreover, these commercial liquid targets for ⁶⁸Ga do not allow production at levels necessary for the distribution of suitable patient doses of PET tracers.

Another cyclotron target option is metallic ⁶⁸Zn targets (as described in, for example, WO 2016/197084), which have shown a higher production capacity of ⁶⁸Ga (5.032 GBq/μAh). However, this strategy has practical challenges associated with the need for cumbersome pre and post irradiation handling of targets. Metallic zinc also has the limitation of a relatively low melting point (419° C.) that prohibits the use of higher beam currents necessary for large scale production of ⁶⁸Ga.

Thus, there remains the need for the development of new targets for the production of gallium radionuclides. Any such targets would desirably have good heat tolerance, thus enabling the attainment of higher production efficiencies. A target which is widely commercially available, or which can be routinely prepared is desired.

The present inventors have surprisingly found that a ceramic zinc phosphate target offers an attractive solution. The target may comprise natural zinc (^{nat}Zn) or it may be enriched with a particular zinc isotope.

### SUMMARY OF INVENTION

Thus, viewed from a first aspect the invention provides a process for the production of gallium radionuclides, comprising irradiating a ceramic zinc phosphate target with a proton beam.

In a particular aspect, the invention provides a process as hereinbefore defined comprising:
providing a plate having a recessed portion, wherein the recessed portion has a surface of ceramic or metal;
placing said target in the recessed portion;
covering the target with a foil such that the target is encapsulated by the foil and the surface of the recessed portion,
securing the foil to the plate such that the target is fixed relative to the plate; wherein the foil has a higher melting temperature than target; and irradiating the encapsulated target with a beam of accelerated particles.

Viewed from another aspect the invention provides the use of a ceramic zinc phosphate target in a process for producing gallium radionuclides.

Viewed from a further aspect, the invention provides the use of ceramic zinc phosphate as a target in a process for producing radionuclides.

In a further aspect, the invention provides a process for the production of gallium radionuclides, comprising irradiating a ceramic zinc target with a proton beam, wherein said ceramic zinc target is produced by an acid base reaction between zinc oxide and an inorganic or organic acid.

### Definitions

The term “target” and “target material” are used interchangeably herein to refer to the material which is irradiated with a proton beam to produce the gallium radionuclides.

### DETAILED DESCRIPTION OF INVENTION

The present invention relates to a process for the production of gallium radionuclides, comprising irradiating a ceramic zinc phosphate target with a proton beam.

Ceramic Zinc Phosphate Target

The ceramic zinc phosphate target may comprise any suitable inorganic material which contains zinc, phosphorus and oxygen. It will be understood that the term “ceramic” is used herein to denote a non-metallic solid material which comprises an inorganic compound held together by ionic and/or covalent bonds.

In a preferable embodiment, the zinc phosphate target has the formula Zn₃(PO₄)₂.xH₂O, wherein x is an integer in the range 0 to 4. Ideally, x is zero, i.e. the zinc phosphate target does not comprise any water. The zinc phosphate target thus preferably consists of zinc, phosphorous and oxygen.

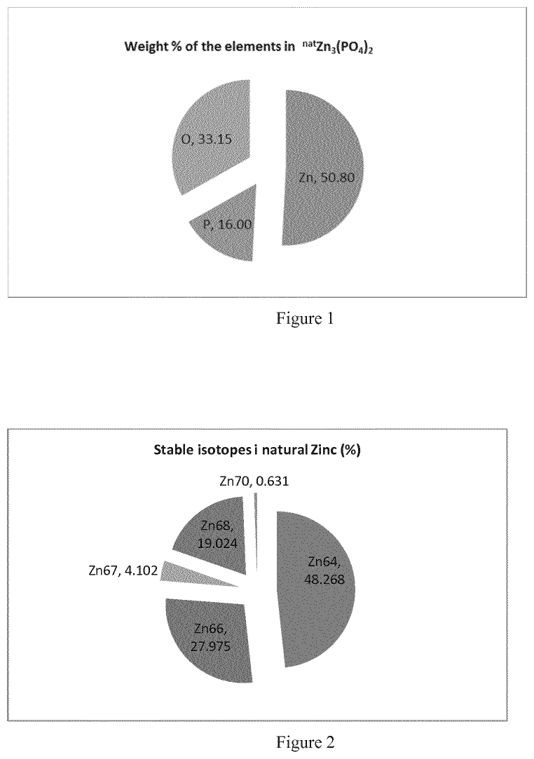

FIG. 1 shows the relative weight percentages of zinc, phosphorous and oxygen in Zn₃(PO₄)₂. Upon irradiation with a proton beam, the zinc atoms transform to produce gallium radionuclides. Besides the 51 wt % zinc, the target also contains phosphorous and oxygen that upon reaction with the proton beam will also produce radioactive material. However, in general, the radioactivity emitted from these elements is very short-lived. For example, ³¹P will usually produce ²⁹⁻³¹S, with half-lives less than 2.5 minutes, from the ³¹P(p, xn)²⁹⁻³¹S reaction. Any radioactive side products can be eliminated from the final Ga product during purification, which typically occurs by dissolving and processing of the target in an acidic or basic solution before chromatographic work up.

The target may comprise natural zinc (^{nat}Zn) or it may be enriched with a particular zinc isotope. The skilled person will appreciate that a suitable zinc isotope may be chosen depending on the required gallium product isotope.

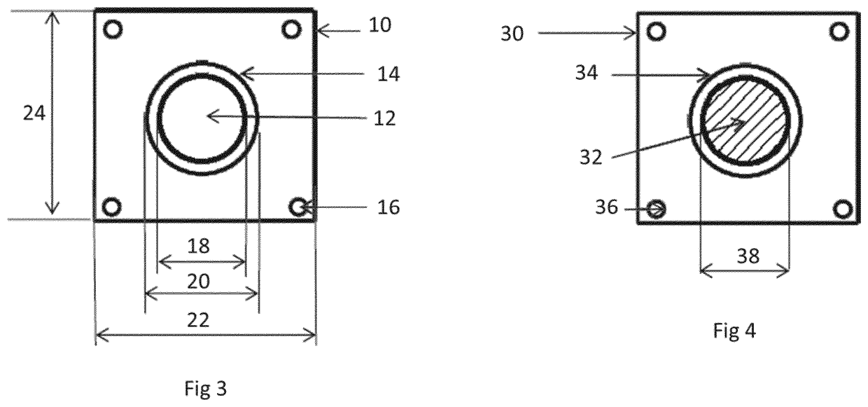

Natural zinc consists of five stable isotopes, as shown in FIG. 2. Three of them are of special interest as target materials for Zn(p, n)Ga nuclear reactions in the context of manufacturing diagnostic radiopharmaceuticals: ⁶⁶Zn, ⁶⁷Zn and ⁶⁸Zn. The skilled person will understand that by “(p,n)” reaction we mean a nuclear reaction during which a proton is added to a nucleus and a neutron is lost. Upon irradiation with the proton beam, ⁶⁸Zn undergoes the ⁶⁸Zn(p, n)⁶⁸Ga reaction to produce ⁶⁸Ga. Similarly, ⁶⁷Zn undergoes the ⁶⁷Zn(p, n)⁶⁷Ga reaction for the production of ⁶⁷Ga and ⁶⁶Zn undergoes Zn undergoes the ⁶⁶Zn(p, reaction for the production of ⁶⁶Ga. Thus, in a preferable embodiment, the zinc phosphate target material comprises Zn which has been enriched with ⁶⁸Zn or ⁶⁷Zn or ⁶⁶Zn. In a particularly preferable embodiment, the Zn in the target material comprises >99% ⁶⁸Zn.

The target material may be made by any suitable method known in the art. Typically, it is produced by mixing zinc oxide (ZnO) with dilute phosphorous acid (H₃PO₄) to produce a hydrated zinc phosphate salt. If it is desired to remove water from the salt, this is typically carried out by heating. In embodiments where an isotope-enriched target material is desired, this is usually obtained by employing a suitably enriched ZnO starting material.

The target material can be prepared in different shapes. In general, the target surface area should be larger than the extension of the beam intercept to cover all the incoming protons. Thus, it will be appreciated that the shape and dimensions of a suitable target material will differ accordingly with beam spread and the choice of target holder. In one aspect, the target material is prepared as a disc for use in the processes of the invention. In one preferable embodiment, the target is in the foitn of a disc with a diameter of 17 mm.

Preferably, the thickness of the disc is in a range so as to provide a “thick target yield”. By “thick target yield” we mean the thickness of the target which gives the maximum yield of the nuclear reaction in question. It will be appreciated that this thickness will vary with different beam energies and different target densities, e.g. for a 16 MeV proton beam typically the thick target thickness is about 2 mm.

The zinc phosphate target material typically has a density in the range 0.1 to 4 g/cm³, preferably 1.5 to 3 g/cm³.

The target material preferably has a mass area in the range 50 to 350 mg/cm², preferably 200 to 290 mg/cm².

The present inventors have surprisingly found that the target of ceramic zinc phosphate has a very high temperature tolerance, of the order of greater than 900° C., allowing for the application of a much higher proton intensity compared to previously known zinc targets. Increased proton intensity leads to higher heat deposition resulting from interactions with the incoming particle beam as well as from the nuclear reaction of transforming zinc to gallium, so it naturally follows that the more heat the target can withstand the greater the proton intensity that can be used.

Process

The process of the invention may be any suitable process known in the art for the production of gallium radionuclides, comprising irradiating a ceramic zinc phosphate target with a proton beam. Typically, the proton beam is provided by a particle accelerator, especially a cyclotron. The skilled person will be familiar with such processes and the instruments employed therein.

The energy level of the proton beam is typically in the range 4 MeV to 30 MeV, preferably 10 MeV to 16 MeV.

The proton beam intensity (also termed “beam current”) is preferably in the range 10 to 1000 μA, more preferably 50 to 300 μA.

The gallium radionuclides produced by the processes of the invention may have activity in the range 0.1 to 10 TBq

The process of the invention preferably produces gallium radionuclides at a rate of greater than 100 MBq/μAh.

In one preferable embodiment, the process of the invention produces gallium-68 radionuclides at a rate of greater than 1 GBq/μAh when the target comprises ^{nat}Zn. In embodiments wherein the target comprises Zn which has been enriched in ⁶⁸Zn, the process preferably produces ⁶⁸Ga at a production rate greater than 6 GBq/μAh. In a particularly preferable embodiment, wherein the target comprises Zn in the form of >99% ⁶⁸Zn, the process may produce ⁶⁸Ga at a production rate greater than 8 GBq/μAh.

In one embodiment the process of the invention may employ a proton beam current of 100 μA to produce 500 to 1000 GBq ⁶⁸Ga.

After irradiation of the ceramic zinc phosphate target with the proton beam, the gallium radionuclide product is typically isolated from any unreacted zinc phosphate and/or other side products, preferably by means of liquid chromatography.

Time of irradiation is typically in the range 10 to 300 minutes, preferably 30 to 120 minutes.

In a particular aspect, the invention provides a process as hereinbefore defined comprising:

providing a plate having a recessed portion, wherein the recessed portion has a surface of ceramic or metal;
placing said ceramic zinc phosphate target in the recessed portion;
covering the target with a foil such that the target is encapsulated by the foil and the surface of the recessed portion,
securing the foil to the plate such that the target is fixed relative to the plate; wherein the foil has a higher melting temperature than target; and irradiating the encapsulated target with a beam of protons.

The foil may have a melting temperature above 1000° C. when the target has a melting temperature below 1000° C. The foil may have an average thickness of from 4 μm to 500 μm. The foil may be a cobalt-containing foil, preferably Havar™ foil that is an alloy consisting of 42.5%-no. Co, 20%-no. Cr 13%-no., Ni and the balance Fe, W, Mo, Mn, plus impurities.

The piece of target material may be a generally planar piece of the target material dimensioned to sit in the recessed portion, preferably wherein a thickness of the generally planar piece of target is between 0.3 mm and 3 mm and a largest dimension of the generally planar piece of target is between 0.2 cm and 10 cm.

The plate may be a plate comprising aluminium.

The encapsulated target may be held fixed relative to the plate by a cover, the cover having an aperture. The aperture may be sized to be larger than a beam diameter of the proton beam for irradiating the encapsulated target.

The plate may be cooled for some or all of the duration of the irradiation process. Cooling may take place by any suitable means, such as by using a constant flow of water. Cooling of the target can preferably be performed from both sides of the target. In current designs of target stations from commercial vendors, the back of the target can be cooled with water and with He-gas in the front. Alternative approaches use water on both sides of the target or even targets immersed in water.

This preferable embodiment is described in more detail below, with reference to FIGS. 3 to 9.

FIG. 3 shows a cover 10 having an aperture 12. The aperture is preferably located in the center of the cover 10. The cover 10 may be made of metal. Preferably, the metal has a high melting point and high heat transfer capacity, such as tantalum, aluminium, gold or copper. Aluminium is described in greater detail below due its low cost, suitable mechanical properties and short-lived activation products from proton irradiation.

The cover 10 of FIG. 3 may be approximately square (i.e. length 24=length 22 in FIG. 3) and have an assembly hole 16 in each corner. These assembly holes 16 are for receiving fasteners 15, such as screws or pins, to hold the cover 10 to a plate 30 that is shown in FIG. 4.

The plate 30, as shown in FIG. 4, may be approximately square and have an assembly hole 36 in each corner for joining the cover 10 to the plate 30. The assembly holes 15 of the cover 10 should align with the assembly holes 36 on the plate 30 when the cover 10 is laid on top of the plate 30. The plate is preferably made of aluminium.

As shown in FIG. 6, the plate 30 may have a recessed portion 32 in the center such that a center of the recessed portion 32 is coaxial with a center of the aperture 12 of the cover 10 when the cover 10 is attached to the plate 30. In one embodiment, the recessed portion 32 is circular and the aperture 12 is circular. In this embodiment, the recessed portion 32 may have a larger diameter 38 than the diameter 18 of aperture 12. Alternatively, the diameter 38 of the recessed portion 32 may be equal to or smaller than the diameter 18 of the aperture 12. The recessed portion 32 does not extend through the entire thickness of the plate 30. That is, the recessed portion 32 may take the form of a blind hole in the plate 30.

Alternatively, the plate 30 and/or the recessed portion 32 may be made from other materials. It is envisaged that many ceramic materials are suitable. Further, the plate 30 and/or recessed portion 32 may be formed from metals that are inert in the presence of the target (at, at least, the melting temperature of the target) and the produced radionuclide. The recessed portion may be a surface of aluminium oxide.

A sealing ring 14, such as an O-ring, may be disposed in the cover 10. A sealing ring 34, such as an O-ring, may be disposed in the plate 30. Preferably, the two sealing rings 14, 34, are of equal size and are located so as to be coaxial when the cover is laid on top of the plate and fastened thereto. The sealing rings 14, 34 are to assist with gripping and sealing when the cover 10 is fastened to the plate 30.

The sealing rings 14, 34 may be rubber. Alternatively, the sealing rings 14, 34 may be any other material that is inert, heat-resistant (to the degree of the target temperature), and sufficiently compressible/sealable to prevent gas leakage when the sealing rings 14, 34 are compressed pressed when the cover 10 is fastened to the plate 30.

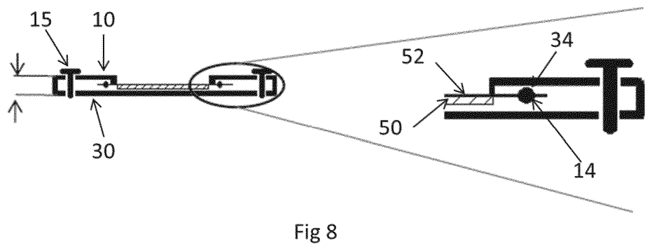

The target 50 may be placed in the recessed portion 32. As shown in FIG. 7, the target 50 may take the shape of a coin having a diameter less than or equal to the diameter 38 of the recessed portion 32. Other shapes are also envisaged for the target 50. Preferably the target 50 is shaped to match the shape of the recessed portion 32. The target material may be inserted as coin sized to fit in the recessed portion, or as multiple pieces, or in powdered form.

After the target 50 has been placed in the recessed portion 32 of the plate 30, a foil 52 may be laid on top of the target 50. The foil 52 may have a melting temperature above that of the target and is preferably made of a material that will not react with the target 50. Preferably, the foil will not interact, or only interact minimally, with the beam of protons. For example, the foil 52 may be a cobalt alloy foil. One suitable cobalt alloy foil is the commercially-available Havar™ foil 52, which is composed of 42.5%-no. Co, 20%-no. Cr, 13%-no. Ni, and the balance Fe, W, Mo, Mn, plus impurities. This foil 52 has a melting temperature of 1480° C. and a thickness suitable for both holding the target material in place and to degrade the incoming proton energy to a suitable value, such as 10 μm and above. Other suitable materials may be used for the foil 52, for example, a foil of Inconel alloy or aluminium may be suitable. Further, different thicknesses of foil may be used. The foil will reduce the energy of the incoming particle beam. Thus, one criterion governing the choice of foil material and thickness is based on the energy of the particle beam. Preferably, the foil material will have a combination of low stopping power as well as being chemically inert and physically stable in the presence of heated target material.

The foil 52 may be dimensioned such that it may be overlaid on the sealing rings 14, 34 of the plate 30 and touch the sealing rings at every point. That is, the foil 52 may be larger than the sealing ring border. For example, the foil shown in FIG. 7 is square and has a side-length greater than diameter 20 of the sealing rings 14, 34 shown in FIGS. 3-6. Preferably, the sealing rings are sufficiently compressible such that, when the cover 10 is fastened to the plate 30, the foil 52 is contacted and held by both the cover 10 and the plate 30.

Alternatively, the foil 52 may be provided integrally with the cover 10. In this embodiment, the aperture 12 consists of a thin portion of the cover, either made from the same material as the cover 10 or from a separate material joined to the cover. This thin portion of the cover 10 is thin so as to limit the energy loss of radiation passing through the aperture, so that radiation may interact with the target nuclide held in the recessed portion, beneath the thin portion that is the aperture 12 of the cover 10.

During assembly, the target 50 may be placed in the recessed portion 32. The foil 52 may then be laid on top of the target 50. The cover 10 may then be placed on top of the plate 30 and the foil 52, such that the sealing ring 14 of the cover 10 presses the foil 52 into the sealing ring 34 of the plate 30. The cover 10 may then be fastened to the plate 30.

Pressure from the cover 10 onto the foil 52, and from the foil 52 onto the target 50 may hold the target 50 in place within the recessed portion 32 of the plate 30. The entire assembly may then be spatially oriented and the target 50 will stay in place within the recess. That is, the target is encapsulated in a region defined by the foil and the recessed portion. If the target 50 extends above the depth of the recessed portion 32, then a portion of the plate between the recessed portion 34 and the sealing ring 34 may also form part of the encapsulating region. For example, the plate 30 may be oriented vertically such that the normal line from the base of the recessed portion 32 points horizontally. Alternatively, the plate 30 may be laid flat such that the normal line from the base of the recessed portion 32 points vertically up or down. That is, the target may be used in any spatial orientation which may increase the number of suitable cyclotrons the target may be used with.

The above-described apparatus may be presented as a target at the output of a cyclotron or other particle accelerator. Hereafter, the disclosure will refer to cyclotrons, but it is to be understood that the invention is not so limited and other particle accelerators may be used as appropriate.

The foil 52, may have a much higher melting temperature than the target. The foil 52 may also prevent any release of radionuclide to the atmosphere. This may be a useful safety feature inherent to this design.

After irradiation by protons, the apparatus may be removed from the cyclotron. The foil 52 is preferably selected to be inert with respect to the target. Further, the foil is preferably selected to be physically stable under the expected heating of the target nuclide. For example, the foil may have a melting temperature higher than, preferably much higher than, the melting temperature of the target. In this case, the irradiated zinc/gallium mix, if melted and resolidified, may be easily separated from both the recessed portion 32 and foil 52.

By way of non-limiting example, the plate 30 and cover 10 may each be 40×40 mm and the aperture 12 of the cover 10 may have a diameter 18 of 10-20 mm, preferably 17 mm. The recessed portion may have a diameter 38 of 20-22 mm and 1.3 mm in depth. The piece of target material 50 may be a cylinder having a diameter of 17 mm and a thickness of 1.68 mm. The foil 52 may be 25×25 mm and 0.01 mm thick. Thus, when the piece of target material 50 is placed in the recessed portion 32, it extends above the rim of the recess by 0.38 mm and the foil 52 thickness adds an extra 0.01 mm. When the cover 10 is fastened to the plate 30, the target material 50 is firmly held in the recessed portion 32 by pressure from the cover 10 holding the foil 52 against the plate 30.

In a further embodiment the invention relates to a process for the production of gallium radionuclides, comprising irradiating a ceramic zinc target with a proton beam, wherein said ceramic zinc target is produced by an acid base reaction between zinc oxide and an inorganic or organic acid. In this embodiment, the zinc target may be selected from the group consisting of zinc sulfate, zinc sulfide, zinc carbonate, zinc acetate, zinc propionate, zinc trimethylacetate and mixtures thereof. It will be understood that all preferable aspects discussed above in the context of the zinc in the zinc phosphate target and the processes employing said target apply equally to this further embodiment.

The invention will now be described with reference to the following non limiting examples and figures.

FIG. 1: Weight percentages of elements in zinc phosphate target

FIG. 2: Isotope distribution in natural zinc

FIG. 3: Plan view of a cover having an aperture in one embodiment of the invention

FIG. 4: Plan view of a plate having a recessed portion in one embodiment of the invention

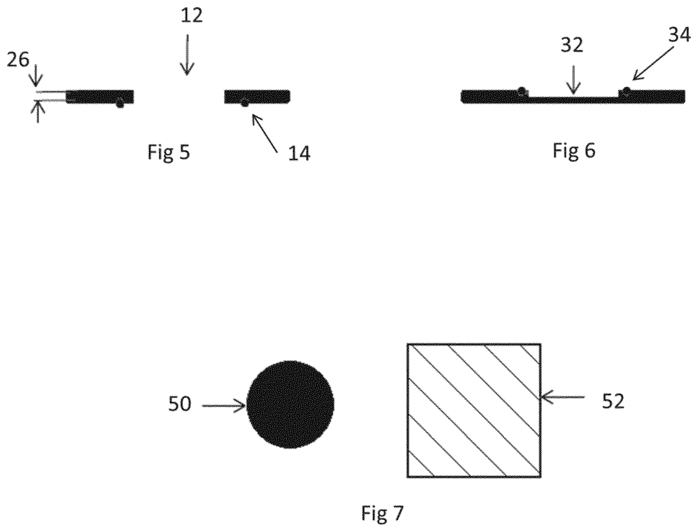

FIG. 5: Side view of the cover of FIG. 3

FIG. 6: Side view of the plate of FIG. 4

FIG. 7: Piece of target material and a piece of foil

FIG. 8: Side view and enlarged side view of the apparatus formed from the cover, plate, target nuclide, and foil in one embodiment of the invention

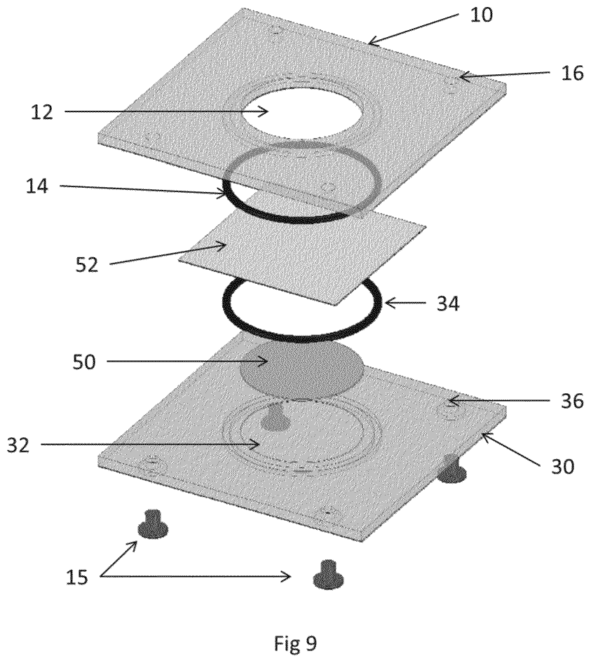

FIG. 9: Exploded view of the apparatus formed from the cover, sealing rings, plate, foil, and target nuclide in one embodiment of the invention

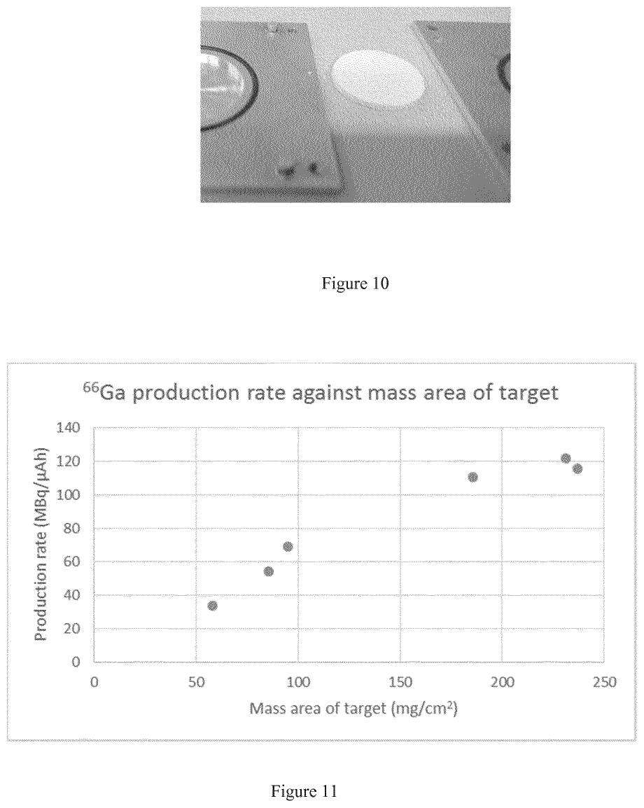

FIG. 10: The ceramic zinc target (mid) is shown between the bottom (left) and top (right) of the target holder

FIG. 11: Production rate with targets of different mass area

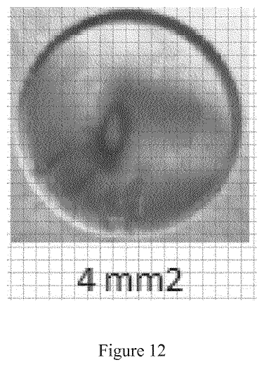

FIG. 12: Image showing surface marks after beam impact with 16 MeV protons on a target foil. The superimposed thread net with mm resolution indicates area of impact.

### EXAMPLES

Proton Beam

The proton beam was produced by a Cyclotron Scanditronix MC-35 instrument. The target station, where the target holder is clamped, is a custom made device made to fix target holders with dimensions 42×40×3 mm. The target surface is held perpendicular to the beam entrance tube. The backing of the target holder is cooled by a constant flow of water.

Dose Calibrator

Activity measurements were carried out on a Capintec CRC 55 tW dose calibrator.

For testing of target physical properties and radioisotope production parameters targets have been made from natural zinc (^{nat}Zn).

Preparation of Target Material

Target material was prepared by mixing zinc oxide (ZnO) with dilute phosphorous acid (H₃PO₄). The resulting cement, consisting of Zn₃(PO₄)₂.4H₂O, is shaped by molding it to compact ceramic discs, or coins, before its spontaneous solidification. The molded coin dimensions are 17 mm in diameter with variable thickness, typically between 0.2-2.0 mm, in order to fit within the target holder. The crystal water is eliminated from the ceramic coin by baking at high temperature for dehydration. The resulting dehydrated ceramic target (FIG. 10) consists basically of zinc phosphate with the formula Zn₃(PO₄)₂.

The current molding process of targets allows for production of only one target at a time, because of the fast and irreversible solidifying process that occurs after mixing of the phosphoric acid and the zinc oxide.

If crystal water was remaining in the target, it would be released and result in an increase in gas pressure under the foil during irradiation. The dehydrating baking step (500-900° C.) of molded targets must have been essentially quantitative since the targets exposure to accelerated proton beams showed intact Havar foil after every exposure.

Nuclear Reactions with Ceramic Targets of ^{nat}Zn

Natural zinc contains five different isotopes. Thus, proton reactions on targets of ^{nat}Zn results in radiogallium isotopes with different half-lives. Here, the investigation of yield from proton-induced reactions was done by quantification of the longer half-life isotope ⁶⁶Ga after about one day after end-of-bombardment, when ⁶⁸Ga has decayed. All quantitative measurements were done by a dose-calibrator with a preset calibration value for ⁶⁶Ga.

Targets with thickness between 0.25 and 1.68 (70-289 mg/cm²) were exposed to 16 MeV protons with different focus area and currents between 2.1 and 2.58 μA.

TABLE 1
Production data from five radiation run on zinc phosphate targets.

| | 1 | 2 | 3.1 | 3.2 | 3-tot | 4 | 5 |
|---|---|---|---|---|---|---|---|
| Weight, g | 0.1611 | 0.238 | 0.262 | 0.378 | 0.641 | 0.516 | 0.657 |
| Thickness, mm | 0.25 | 0.7 | 0.52 | 0.93 | 1.45 | 1.24 | 1.68 |
| Density, g/cm³ | 2.83 | 1.5 | 2.22 | 1.79 | 1.95 | 1.84 | 1.72 |
| Mass area, mg/cm² | 70.8 | 104.8 | 115.6 | 166.6 | 282.2 | 227.3 | 289.4 |
| Current, μA | 2.1 | 2.27 | 2.58 | 2.58 | 2.58 | 2.35 | 2.1 |
| Time, min | 10 | 10 | 10 | 10 | 10 | 10 | 10 |
| Activity, MBq | 11.7 | 20.5 | 29.4 | 22.6 | 52 | 43.2 | 40.3 |
| Rate, MBq/μAh | 33.4 | 54.2 | 68.8 | 52.6 | 121.2 | 110.6 | 115.4 |
| Rate/mass area, | 0.471 | 0.517 | 0.591 | 0.315 | 0.429 | 0.487 | 0.399 |
| MBq/μAh/mg/cm² | | | | | | | |

Note:
all measured activities are 35% lower than true values because of self-absorption of radiation in the detector. Run three comprises a target sandwich of two discs with 3.1 on top against the beam entrance.

The resulting amount of activity (Bq) is normalized with current (μA) and irradiation time (h) during bombardment to production rate (Bq/(μAh). Calculated values for all runs are plotted against the respective mass area (mg/cm²) in order to display the effect of different target densities (FIG. 11). The mass area is calculated from the target weight divided by the area of the circular target disk (2.27 cm²). The true mass of zinc in the target in natural zinc is 51% of the calculated value that is based on the total target weight.

FIG. 11 shows a linear increase of the production rate of ⁶⁶Ga up to about 150 mg/cm² in mass area. The decrease in slope at higher values of target mass area indicates approximity to the expected thick target yield (between 200 and 300 mg/cm² totally, or 100-200 mg/cm² related to the zinc content) for the used proton energy. Thick target yield is a constant showing the smallest mass area for when maximum production rate is achieved.

Calculation of Production Rate for ⁶⁸Ga

At present, the highest measured production rate for ⁶⁶Ga with our preliminary natural zinc target is 163.6 MBq/μAh with a 282 mg/cm² target (value is corrected for detector efficiency). With a natural zinc metal target, Engle et al. (2012) demonstrated that ⁶⁸Ga is produced 10 times more efficient than ⁶⁶Ga with 13 MeV protons. Extrapolating this to our target values for ⁶⁶Ga could give a production rate for ⁶⁸Ga with the natural zinc ceramic target of the invention of 1.636 GBq/μAh (163.6 MBq/μAh×10).

Cyclotron production of ⁶⁸Ga for clinical use requires isotope enriched [⁶⁸Zn]zinc to avoid other gallium isotopes within the product. Based on the isotope % of ⁶⁸Zn in ^{nat}Zn (19.024%), it is calculated that a ceramic target of which the Zn is 100% ⁶⁸Zn will yield 8.61 GBq/μAh⁶⁸Ga, 5.26 times more than that of a target with a natural ratio of the zinc isotopes.

Beam Intensity

The current maximum available beam current at the external target position have so far been approximately 2.6 μA. Literature data from production of ⁶⁸Ga by liquid targets now on marked have been limited to 40 μA, and a relatively low production rate, 192.5 MBq/μAh. A more realistic production setting for clinical scale production will be in the range 40-100 μA for a target such as the ceramic target with the much higher production rate of 8 GBq/μAh.

Experiments performed with a 2.3 μA beam (FIG. 12) of focused protons, enabled investigation of target material integrity toward high beam current. Our results with a 2.3 μA beam showed, with a 4 mm² impact area, that the target could withstand a 57 times higher current if distributed evenly on the available 227 mm² target area. Hence, results from these tolerance experiments shows target resistance with high currents in the range of 100 μA proton beam sufficient for production of 500-1000 GBq ⁶⁸Ga. This activity level allows for multi dose production and satellite center distribution.

Estimates from our preliminary results on the new target predict production rates of ⁶⁸Ga about 8 GBq/μAh which is higher than earlier reported metal targets, about 5 GBq/μAh.

The combination of our new invented target material, with the target holder, enables proton beams with proton currents necessary for large scale nuclide production, 500-1000 GBq ⁶⁸Ga.

1. A process for the production of gallium radionuclides, comprising irradiating a ceramic zinc phosphate target with a proton beam.

2. The process of claim 1, wherein the proton beam is provided by a particle accelerator.

3. The process of claim 1, wherein the ceramic zinc phosphate target has the formula Zn₃(PO₄)₂.xH₂O, wherein x is an integer in the range 0 to 4.

4. The process of claim 1, wherein the ceramic zinc phosphate target comprises zinc in the form of ^{nat}Zn.

5. The process of claim 1, wherein the ceramic zinc phosphate target comprises zinc enriched in ⁶⁸Zn, ⁶⁷Zn, or ⁶⁶Zn.

6. The process of claim 1, wherein the ceramic zinc phosphate target comprises zinc that is >99% ⁶⁸Zn.

7. The process of claim 1, wherein the ceramic zinc phosphate target has a density in the range 0.1 to 4 g/cm³.

8. The process of claim 1, wherein the proton beam has an energy level in the range 4 MeV to 30 MeV.

9. The process of claim 1, wherein the proton beam has an intensity in the range 10 to 1000 μA.

10. The process of claim 1, comprising the steps:
providing a plate having a recessed portion, wherein the recessed portion has a surface of ceramic or metal;
placing the ceramic zinc phosphate target in the recessed portion;
covering the ceramic zinc phosphate target with a foil such that the ceramic zinc phosphate target is encapsulated by the foil and the surface of the recessed portion,
securing the foil to the plate such that the ceramic zinc phosphate target is fixed relative to the plate;
wherein the foil has a higher melting temperature than ceramic zinc phosphate target; and
irradiating the encapsulated ceramic zinc phosphate target with the proton beam.

11. The process as claimed in claim 10, wherein the foil is a cobalt-containing foil.

12. (canceled)

13. (canceled)

14. A process for the production of gallium radionuclides, comprising irradiating a ceramic zinc target with a proton beam, wherein said ceramic zinc target is produced by an acid base reaction between zinc oxide and an inorganic or organic acid.

15. The process as claimed in claim 14, wherein the ceramic zinc target is selected from the group consisting of zinc sulfate, zinc sulfide, zinc carbonate, zinc acetate, zinc propionate, zinc trimethylacetate and mixtures thereof.

16. The process of claim 3, wherein the zinc is in the form of ^{nat}Zn.

17. The process of claim 3, wherein the zinc is enriched in ⁶⁸Zn, ⁶⁷Zn, or ⁶⁶Zn.

18. The process of claim 3, wherein the zinc is >99% ⁶⁸Zn.

19. The process of claim 1, wherein the ceramic zinc phosphate target has a density in the range 1.5 to 3 g/cm³.

20. The process of claim 1, wherein the proton beam has an energy level in the range 10 MeV to 16 MeV.

21. The process of claim 1, wherein the proton beam has an intensity in the range 50 to 300 μA.
